(19) United States
(12) Patent Application Publication
(10) Pub. No.: US 2011/0202685 A1
(43) Pub. Date: Aug. 18, 2011

(54) System and Method for Communication Between an Information Handling System and Management Controller Through a Shared LOM

(76) Inventors: Narayanan Subramaniam, Bangalore (IN); Elie Jreij, Pflugerville, TX (US); Hendrich M. Hernandez, Round Rock, TX (US)

(21) Appl. No.: 12/706,085

(22) Filed: Feb. 16, 2010

(51) Int. Cl. G06F 15/16

(52) U.S. Cl. 709/245

(57) ABSTRACT

Communications between a host information handling system and its management controller sent through a shared LOM are re-directed at the LOM from communication through a network to instead communicate directly between the host information handling system and management controller. A management module compares destination addresses of packets sent from the host information handling system and the management controller with host information handling system and management controller network addresses stored on the LOM. Packets having destination address that match a host information handling system or management controller network address are redirected from communication across the network to communicate directly between the host information handling system and management controller.

### BACKGROUND OF THE INVENTION

1. Field of the Invention

The present invention relates in general to the field of information handling system management, and more particularly to a system and method for communication between an information handling system and management controller through a shared LOM.

2. Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Information handling system servers provide important network services for enterprises and individuals. To improve reliability of networks, information handling systems often include management controllers, such as baseboard management controllers (BMC), that support off-line management functions. For example, a management controller typically supports remote power up and power down of a server system as well as remote maintenance. A recent feature added to some management controllers is a consolidated out of band console that allows users to inventory and monitor server hardware without a host operating system based management console. A host server information handling system includes lightweight agents that collect system management data not directly available on the management controller, such as operating system type and version, storage (PERC) data and network interface card (NIC) statistics. The management controller retrieves host server information through an internal Ethernet-based management plane that provides Internet Protocol (IP) level connectivity between the management controller and host server through a host server LAN on motherboard (LOM) and network controller sideband interface (NC-SI) interconnect. This internal Ethernet management plane is known as an operating system baseboard management controller passthru (OS-BMC PT).

One difficulty that arises with the use of an OS-BMC Passthru is that the server operating system and management controller are configured to communicate on externally different virtual LANs (VLANs) and or different IP subnets. The different subnets are, in some cases, not IP reachable to each other even through external routers. This type of configuration helps to isolate external systems management traffic to the management controller from host operating system traffic that carries sensitive data. However, passthru communication through the host server operating system and management controller typically functions correctly only if the host operating system and management controller are on the same VLAN and IP subnet. An OS-BMC PT typically will not function properly if the host operating system and management controller are on the same IP subnet but different VLANs or if the host operating system and management controller are on different external subnets which are not IP reachable to each other.

### SUMMARY OF THE INVENTION

Therefore a need has arisen for a system and method which facilitates communication between a management controller and host operating server OS-BMC PT regardless of end user configured IP networking settings.

In accordance with the present invention, a system and method are provided which substantially reduce the disadvantages and problems associated with previous methods and systems for communications between a host information handling system and management controller. A networking device shared by the host information handling system and the management controller, such as a LOM, includes tables that identify network destination addresses associated with the host information handling system and management controller. Packets sent to the networking device from the host information handling system and management controller are monitored to identify destination addresses associated with the host information handling system and management controller, and then switched to proceed to the host information handling system or management controller without proceeding through an external network interfaced with the networking device. Packet monitoring is performed by monitoring IP address or VLAN tag information of the packets.

More specifically, a host information handling system is managed by a management controller, such as a baseboard management controller (BMC). The host information handling system and management controller communicate with an external network, such as the Internet, through a shared networking device, such as a LAN on Motherboard (LOM). A management module executing on the LOM monitors packets sent from the host information handling system to detect destination addresses associated with the management controller and switches detected packets to proceed directly to the management controller without traversing a network interfaced with the LOM. For example, the management module monitors the IP address or VLAN tag identifier associated with packets. The management module monitors packets sent from the management controller to detect destination addresses associated with the host information handling system and switches detected packets to proceed directly to the host information handling system without traversing a network interfaced with the LOM. Re-directing packets makes Ethernet management plane communications possible where the host information handling system and management controller are otherwise IP unreachable, such as where the host information handling system and management controller are on different IP subnets.

The present invention provides a number of important technical advantages. One example of an important technical advantage is that secure communications is facilitated between a management controller and host operating system at an Ethernet passthru regardless of end user configured IP network settings. For example, communications between a management controller and operating system occur through a LOM of an information handling system if the host operating system and management controller are on the same IP subnet but different VLANs, on different external IP subnets which are not IP reachable to each other, and on the same IP subnet and same VLAN. Monitoring IP address or VLAN identifier information captures relevant packets not identifiable by MAC address, such as where communication occurs between different subnets.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a host information handling system and management controller sharing communications through a common LOM; and

FIG. 2 depicts a flow diagram of a process for re-directing communications from a management controller to a host information handling system through an Ethernet management plane instead of a network;

FIG. 3 depicts a flow diagram of a process for re-directing communications from a host information handling system to a management controller through an Ethernet management plane instead of a network;

FIG. 4 depicts a block diagram of a host information handling system and management controller communicating through a shared LOM networking device; and

FIG. 5 depicts a flow diagram of a process for configuring a networking device to re-direct communications from a network to an Ethernet management plane.

### DETAILED DESCRIPTION

Re-directing network communications at a LOM from communication to a network to instead communicate across an Ethernet management plane improves communication between a host information handling system and management controller. For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device, such as a server, and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

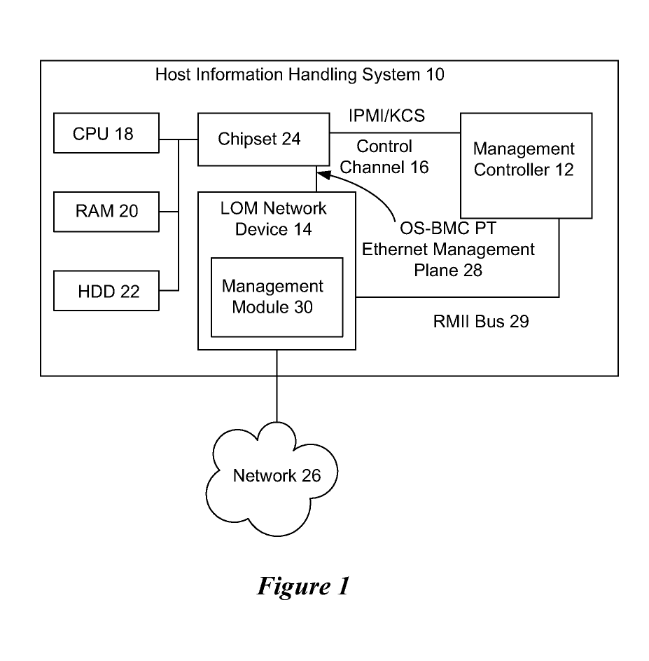

Referring now to FIG. 1, a block diagram depicts a host information handling system 10 and management controller 12 sharing communications through a common LOM network device 14. Management controller 12 is, for example, a baseboard management controller (BMC) that performs remote functions for host information handling system 10, such as remote power up and power down or remote end user inputs through an IPMI KCS control channel 16. Host information handling system 10 processes information with a plurality of processing components, such as a processor 18, RAM 20, a hard disk drive 22 and a chipset 24. LOM network device 14 supports communications by host information handling system 10 processing components with a network 26, such as with conventional IP packets and network addresses, such as IP addresses, MAC addresses and Virtual LAN identifiers. Host information handling system 10 and management controller 12 each interface with LOM network device 14 through an OS-BMC PT Ethernet management plane 28. For example, OS-BMC PT Ethernet management plane 28 is a virtual Ethernet plane supported through a PCIe connection between chipset 24 or processor 18, and RMII bus 29 or other network controller side band interface (NC-SI) between management controller 12 and LOM networking device 14, and filtering logic within LOM network device 14.

Host information handling system 10 and management controller 12 communicate directly with each other through LOM network device 14 using normal packet networking addresses if the operating system executing on processor 18 and management controller 12 have Ethernet IP addresses on the same IP subnet and VLAN. Conventional systems check MAC address information to intercept traffic between a host information handling system and management controller are located on the same subnet. If the operating system executing on processor 18 and management controller 12 are on the same IP subnet but different VLANs, conventional communications through OS-BMC PT Ethernet management plane 28 are not functional unless an external router on network 26 is configured to allow network communications between the different VLANs. If the operating system executing on processor 18 and management controller 12 are different IP subnets that are IP unreachable, then OS-BMC PT Ethernet management plane conventional communications are not functional through network 26.

To ensure that network communications between host information handling system 10 and management controller 12 through OS-BMC PT Ethernet management plane 28 reach each other, a management module 30 on LOM networking device 14 monitors network packets and re-directs packets as necessary from communication through network 26 to instead communicate through OS-BMC PT Ethernet management plane 28. Management module 30 performs a deeper packet inspection to check for IP address and VLAN identifier information, known as the Layer 3 networking layer, rather than the MAC address whose value might reflect a network router rather than the network destination. For example, a network packet sent from management controller 12 to a destination address associated with processor 18 through LOM networking device 14 is intercepted by management module 30 based upon the IP destination address or VLAN identifier so that the packet proceeds directly to host information handling system 10 through OS-BMC PT Ethernet management plane 28 instead of proceeding through network 26. Similarly, a network packet sent from host information handling system 10 to a destination address associated with management controller 12 through LOM networking device 14 is intercepted by management module 30 based upon the IP destination address or VLAN identifier so that the packet proceeds directly to management controller 12 through OS-BMC PT Ethernet management plane 28 instead of proceeding through network 26. Management module 30 is, for example, firmware stored in a computer readable medium of LOM network device 14 that executes on a processor within LOM network device 14.

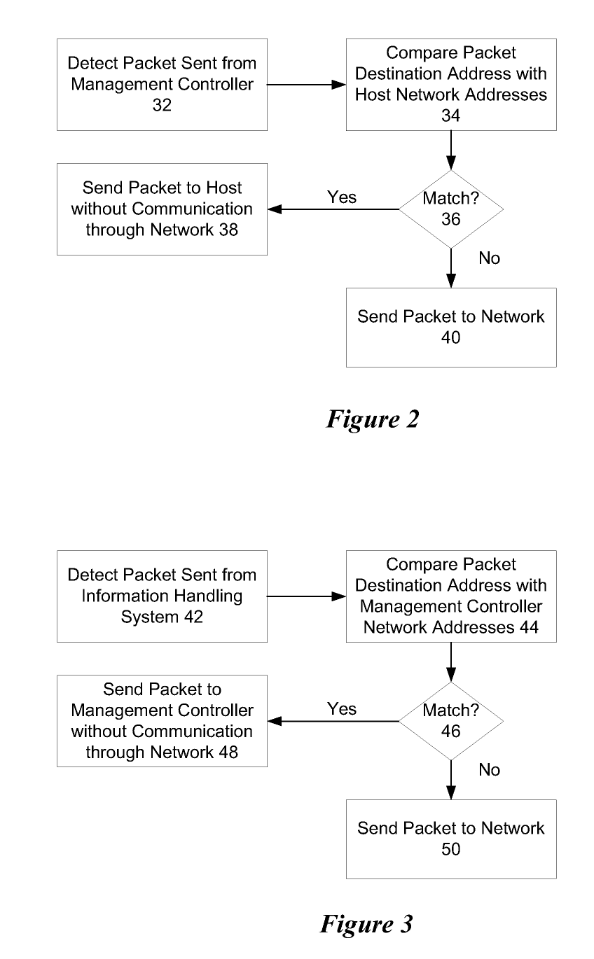

Referring now to FIG. 2, a flow diagram depicts a process for re-directing communications from a management controller to a host information handling system through an Ethernet management plane instead of a network. The process begins at step 32 with detection of a packet sent from a management controller to a networking device, such as a LOM, that is interfaced with both the management controller and a host processor operating system, such as through an Ethernet management plane. At step 34, the destination address of the packet is compared with one or more network addresses of the host processor operating system, such as the host IP address, MAC address or VLAN identifier. At step 36, a determination is made of whether the packet destination address matches a network address of the host information handling system, such as the IP address, MAC address or VLAN identifier associated with an operating system executing on a processor of the host information handling system. If a match exists between the destination address and the host server information handling system network address, then the process continues to step 38 to send the packet to the host information handling system through the Ethernet management plane without proceeding through the network. If a match does not exist, the process continues to step 40 to send the packet to the destination address through the network.

Referring now to FIG. 3, a flow diagram depicts a process for re-directing communications from a host information handling system to a management controller through an Ethernet management plane instead of a network. The process begins at step 42 with detection of a packet sent from a host information handling system to a networking device, such as a LOM, that is interfaced with both the host processor operating system and management controller, such as through an Ethernet management plane. At step 44, the destination address of the packet is compared with one or more network addresses of the management controller, such as the management controller IP address, MAC address or VLAN identifier. At step 46, a determination is made of whether the packet destination address matches a network address of the management controller, such as the IP address, MAC address or VLAN identifier associated with the management controller. If a match exists between the destination address and the management controller network address, then the process continues to step 48 to send the packet to the management controller through the Ethernet management plane without proceeding through the network. If a match does not exist, the process continues to step 50 to send the packet to the destination address through the network.

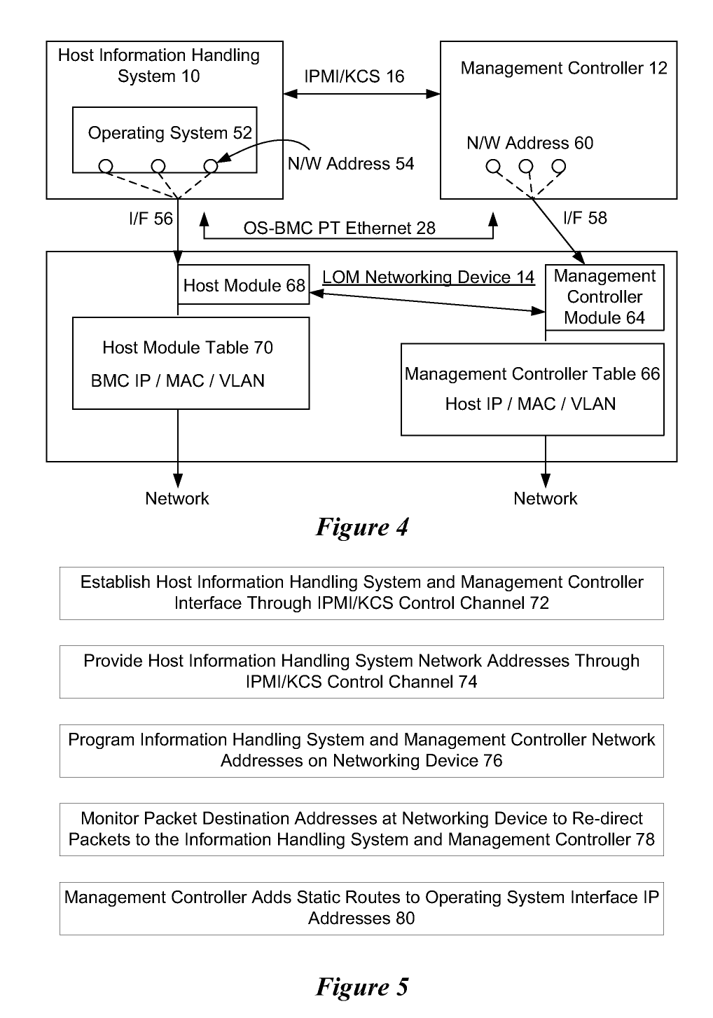

Referring now to FIG. 4, a block diagram depicts a host information handling system 10 and management controller 12 communicating through a shared LOM networking device 14. Host information handling system 10 executes an operating system 52 that uses plural network addresses 54 to communicate with networks through an interface 56 with LOM networking device 14. Management controller 12 has a first interface 58 with LOM networking device 14 that communicates with networks using a network address 60, and may also communicate with a chassis manager through a separate management bus. Network packets sent by management controller 12 to LOM networking device 14 through interface 58 are received by a management controller module 64 for processing to determine if the destination address of the packet is associated with host information handling system 10. Management controller module 64 compares the packet destination address of the packet received from management controller 12 with destination addresses stored in a management controller table 66, such as IP addresses, MAC addresses or VLAN identifiers used by host information handling system 10. If the destination address matches a network address associated with host information handling system 10, then management controller module 64 redirects the packet from proceeding to a network to instead communicate directly through LOM networking device 12 to interface 56 and information handling system 10 without proceeding through an external network. If the destination address does not match an address associated with host information handling system 10, then the packet is sent to the network in a conventional manner. Similarly, a host module 68 monitors packets sent from host information handling system 10 to compare packet destination addresses with network addresses stored in a host module table 70 that are associated with management controller 12. If the destination address of a packet sent by host information handling system 10 matches a network address of management controller 12 stored in host module table 70, then the packet is redirected to proceed directly to management controller 12 instead of to an external network. If the destination address does not match a network address of management controller 12, then the packet proceeds to an external network in a conventional manner. Management controller table 66 and host module table 70 are populated with appropriate network addresses by communicating the network addresses between host information handling system 10 and management controller 12 through IPMI/KCS control channel 16. For example, IPMI/KCS control channel 16 is used by host information handling system 10 to send its MAC/IP/VLAN settings to management controller 12. Management controller 12 uses interface 58 to tell LOM networking device 12 to populate table 70 based upon the host information. Management controller 12 also tells LOM networking device 12 to populate table 66 based on internal management controller settings.

Referring now to FIG. 5, a flow diagram depicts a process for configuring a networking device to re-direct communications from a network to an Ethernet management plane. The process begins at step 72 with operation of an IPMI/KCS control channel established between a physical operating system or Hypervisor of the host information handling system and management controller. At step 74, the host information handling system provides to the management controller the physical operating system and/or Hypervisor interface IP addresses and associated MAC addresses plus and VLAN identifiers used by the host information handling system. The host information handling system periodically updates the network addresses as needed to ensure that the management controller maintains current network address information, such as due to changes caused by dynamic IP address assignment or static IP address updates. In one embodiment, a software or firmware module executing on a processor of the host information handling system automatically provides the network addresses to the management controller.

At step 76, the management controller interfaces with the LOM networking device to program network address information in memory of the LOM networking device. For example, the management controller programs its own IP address, including dynamic and static IP address updates, its own MAC address, its own VLAN identifiers, and the network addresses provided to the management controller by the host information handling system. The network addresses stored in the LOM networking device are the network addresses that are used by the host information handling system and management controller to receive information through the LOM networking device so that packets with a destination address to either the host information handling system or management controller are identifiable at the networking device. At step 78, the networking device firmware uses the network addresses to set up Layer-3 forwarding tables. In one embodiment, one table includes network addresses for use in packets emanating from the management controller so identify packets destined for the host information handling system. For example, if the destination IP address is from the management controller to the host operating system interface IP, then the MAC address is set to the operating system interface MAC address and the VLAN ID is set to the operating system VLAN ID should a VLAN exist, so that the packet is switched from the networking device directly to the host operating system. If the destination IP address is from the host operating system to the management controller, then the MAC address is set to the management controller MAC address and VLAN ID if one exists, so that the packet is switched from the networking device directly to the management controller. At step 80, the management controller adds static routes to the operating system interface packets that egress from the management controller. The static routes fixes bi-directional data transfer so that operating system communications with a management controller makes LOM filtering beyond MAC filtering unnecessary. Monitoring packets at a networking device to detect and redirect communications between a host and a management controller avoids unnecessary and sometimes non-operational network communications where the host and management controller share a common networking device. In one embodiment, the management controller may have multiple network interfaces and addresses. These interfaces can also be programmed to the LOM filtering tables to allow OS-BMC PT to all of the interfaces.

Although the present invention has been described in detail, it should be understood that various changes, substitutions and alterations can be made hereto without departing from the spirit and scope of the invention as defined by the appended claims.

What is claimed is:

1. An information handling system comprising:
a processor operable to process information;
memory interfaced with the processor and operable to store information;
a networking device interfaced with the processor and operable to communicate information between the processor and a network;
a management controller interfaced with the networking device, the networking device operable to communicate information between the processor and a network; and
a management module on the networking device, the management module operable to detect communications between the processor and management controller sent to the network and to direct the detected communications between the processor and management controller without proceeding through the network.

2. The information handling system of claim 1 wherein the networking device comprises a LOM.

3. The information handling system of claim 2 wherein the processor and management controller interface with the LOM through a virtual Ethernet management plane.

4. The information handling system of claim 1 wherein the management module comprises:
a host table having network addresses associated with the management controller; and
a host module interfaced with the host table and operable to detect communications from the host directed to the network having network addresses associated with the management controller and to re-direct the detected communications from the network to the management controller.

5. The information handling system of claim 1 wherein the management module comprises:
a management controller table having network addresses associated with the processor; and
a management controller module interfaced with the management controller table and operable to detect communications from the management controller directed to the network having network addresses associated with the processor and to re-direct the detected communications from the network to the processor.

6. The information handling system of claim 1 further comprising:
a control channel interfacing the processor and the management controller;
a host interface associated with the processor and operable to provide host network information to the management controller; and
a management controller interface associated with the management controller and operable to provide the management module with the host network information and management controller network information.

7. The information handling system of claim 6 wherein the control channel comprises an IPMI interface.

8. The information handling system of claim 6 wherein the host network information comprises one or more of an IP address, a MAC address or a VLAN identifier.

9. The information handling system of claim 6 wherein the management controller information comprises one or more of an IP address, a MAC address or a VLAN identifier.

10. A method for communicating between a host information handling system and a management controller, the method comprising:
communicating a packet of information from the management controller to a network device, the packet having a destination address to a network interfaced with the network device;
detecting at the network device that the destination address matches a host information handling system network address; and
re-directing the packet from communication to the network to communication to the host information handling system interfaced with the network device.

11. The method of claim 10 further comprising:
communicating a packet of information from the host information handling system to a network device, the packet having a destination address to a network interfaced with the network device;
detecting at the network device that the destination address matches a management controller network address;
re-directing the packet from communication to the network to communication to the management controller interfaced with the network device.

12. The method of claim 10 wherein the network device comprises a LOM coupled to the host information handling system and the management controller.

13. The method of claim 10 wherein the destination address comprises an IP address.

14. The method of claim 10 wherein the destination address comprises a MAC address.

15. The method of claim 10 wherein the destination address comprises a VLAN identifier.

16. The method of claim 10 wherein detecting at the network device further comprises:
comparing the destination address with one or more host information handling system addresses stored on the network device; and
finding a match if the destination address matches the one or more host information handling system addresses stored on the network device.

17. The method of claim 16 wherein the one or more host information handling system addresses comprises a layer 3 network address.

18. A networking device comprising:
a first interface coupled to a host information handling system;
a second interface coupled to a management controller;
at least one port operable to communicate with a network;
a management module executing on a processor, the management module operable to detect communications between the host information handling system and the management controller, the communications addressed to communicate through the network port, and to direct the detected communications between the host information handling system and management controller through the first and second interfaces without proceeding through the network port.

19. The networking device of claim 18 further comprising at least one table having network addresses of the host information handling system, wherein the management module detects communications from the management controller to the host information handling system by comparing network destinations of packets sent by the management controller with the host information handling system network addresses.

20. The networking device of claim 18 further comprising at least one table having network addresses of the management controller, wherein the management module detects communications from the host information handling system to the management controller by comparing network destinations of packets sent by the host information handling system the management controller network addresses.
